(19) United States
(12) Patent Application Publication
(10) Pub. No.: US 2022/0414477 A1
(43) Pub. Date: Dec. 29, 2022

(54) EXPLAINING A THEOREM PROVING MODEL

(71) Applicant: International Business Machines Corporation, Armonk, NY (US)

(72) Inventors: Gabriele Picco, Dublin (IE); Thanh Lam Hoang, Maynooth (IE); Marco Luca Sbodio, Castaheany (IE); Vanessa Lopez Garcia, Dublin (IE); Natalia Mulligan, Dublin (IE)

(21) Appl. No.: 17/358,148

(22) Filed: Jun. 25, 2021

(51) Int. Cl. G06N 5/00; G06N 5/02

(52) U.S. Cl. CPC G06N 5/006; G06N 5/02

(57) ABSTRACT

In an approach for explaining a theorem proving model, a processor predicts a truth value of a query through a pre-trained theorem proving model, based on the query and one or more facts and rules in a knowledge base. A processor ranks the one or more facts and rules according to contribution, calculated in a pre-defined scoring method, made to the predicted truth value of the query. A processor generates a proof of the predicted truth value, wherein the proof is one or more logical steps that demonstrate the predicted truth value in a natural language. A processor outputs the proof.

### BACKGROUND

The present disclosure relates generally to the field of automated theorem proving, and more particularly to explaining a theorem proving model with proofs being explicitly generated.

Automated theorem proving (automated deduction) is a subfield of automated reasoning and mathematical logic dealing with proving mathematical theorems by computer programs. Automated reasoning over mathematical proof has been a major impetus for the development of computer science. Automated theorem prover may deal with the development of computer programs that show that some statement (conjecture) is a logical consequence of a set of statements (axioms).

### SUMMARY

Aspects of an embodiment of the present disclosure disclose an approach for explaining a theorem proving model. A processor predicts a truth value of a query through a pre-trained theorem proving model, based on the query and one or more facts and rules in a knowledge base. A processor ranks the one or more facts and rules according to contribution, calculated in a pre-defined scoring method, made to the predicted truth value of the query. A processor generates a proof of the predicted truth value, wherein the proof is one or more logical steps that demonstrate the predicted truth value in a natural language. A processor outputs the proof.

### BRIEF DESCRIPTION OF THE DRAWINGS

FIG. 1 is a functional block diagram illustrating a theorem proving explanation environment, in accordance with an embodiment of the present disclosure.

FIG. 2 is a flowchart depicting operational steps of a cognitive engine within a computing device of FIG. 1, in accordance with an embodiment of the present disclosure.

FIG. 3 is a flowchart depicting operational steps of a proof generator of the cognitive engine included in the computing device of FIG. 1, in accordance with an embodiment of the present disclosure.

FIG. 4 illustrates an exemplary functional diagram of the cognitive engine within the computing device of FIG. 1, in accordance with an embodiment of the present disclosure.

FIG. 5 is an example table illustrating ranking facts and rules using Shapley values of a ranker in the cognitive engine within the computing device of FIG. 1, in accordance with an embodiment of the present disclosure.

FIG. 6 is a block diagram of components of the computing device of FIG. 1, in accordance with an embodiment of the present disclosure.

### DETAILED DESCRIPTION

The present disclosure is directed to systems and methods for explaining a theorem proving model with proofs being explicitly generated.

Embodiments of the present disclosure recognize a need for explaining a neural theorem proving model with proofs being explicitly generated. Automated theorem proving is a subfield of automated reasoning and mathematical logic dealing with proving mathematical theorems by computer programs. Automated reasoning over mathematical proof has been a major impetus for the development of computer science. Automated theorem proving may deal with the development of computer programs that show that some statements (conjecture) are logical consequence of a set of statements (axioms). Embodiments of the present disclosure disclose explicit reasoning procedure where a proof path is provided as an output of a solution. Embodiments of the present disclosure disclose systems and methods for explaining a neural theorem prover. Embodiments of the present disclosure disclose combining an algorithm with a module-agnostic explanation framework for generating an explanation (the proof) of a predicted truth value of the query from a neural theorem proving model. Embodiments of the present disclosure disclose a possible textual explanation for a predicted truth value from a neural theorem proving model.

Embodiments of the present disclosure disclose ranking facts and rules according to contribution made to a predicted truth value of a query, performed by a neural theorem proving model. Embodiments of the present disclosure disclose generating possible proofs ranked by importance (a proof is a set logical steps that demonstrate the predicted value) for the predicted truth value of the query. Embodiments of the present disclosure disclose a lexical negation operator which may take as input a textual query and may provide as output the same query with inverted meaning. Embodiments of the present disclosure disclose a query decomposer operator which may take as input a query and may provide as output the same query (if no disjunction or conjunction is detected) or the query split into two parts by removing the conjunction or disjunction. Embodiments of the present disclosure disclose a lexical unifier operator which may perform a lexical unification of a given query with a fact or rule, emulating the logical unification. Embodiments of the present disclosure disclose aggregating resolvents for every branch in a proof set to create textual proofs. Embodiments of the present disclosure disclose that a proof rank value can be obtained by multiplying all the predictions confidence of each probabilistic model used in deriving a branch. Embodiments of the present disclosure disclose integrating a user-provided feedback.

Embodiments of the present disclosure disclose computing proofs of results of a neural theorem proving model based on a natural language. Embodiments of the present disclosure disclose a sorted set of top-k proofs of a predicted truth value for a query computed by a neural theorem proving model. Embodiments of the present disclosure disclose ranking a proof based on a score that represents the estimated accuracy of the proof. Embodiments of the present disclosure disclose that the proof may include a proof path. A proof path may be the sequences of facts and/or rules from a knowledge base that prove the predicted truth value of query. Each proof may have a single path. Embodiments of the present disclosure disclose that each proof may be a possible explanation of how a neural theorem proving model uses the information in the knowledge base to prove the query. Embodiments of the present disclosure disclose a user may provide feedback on the proof produced as output by an example system. The feedback may include quantitative indication of the correctness/usefulness of the proof. Embodiments of the present disclosure disclose that the computation of proofs may use previously collected user feedback to improve the accuracy of the computation.

Embodiments of the present disclosure disclose taking a knowledge base and a question in a natural language together with a prediction of a neural theorem proving model and outputting an explanation as a list of ranked candidate proofs that the model used to support the prediction. Embodiments of the present disclosure disclose generating a proof for any given neural theorem prover. Embodiments of the present disclosure disclose a method that provides as output an explanation as a set of ranked candidate proofs that the model potentially used to support the prediction.

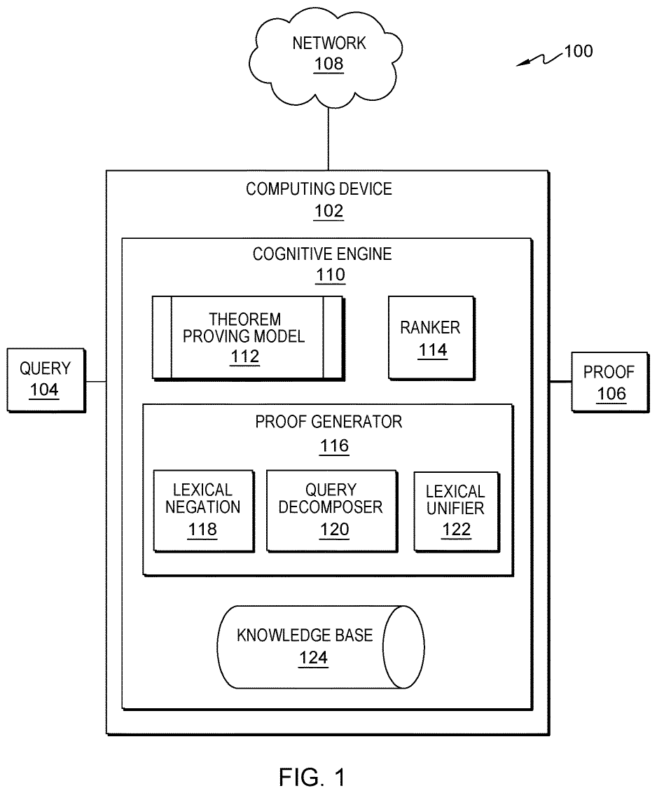

The present disclosure will now be described in detail with reference to the Figures. FIG. 1 is a functional block diagram illustrating a theorem proving explanation environment, generally designated 100, in accordance with an embodiment of the present disclosure.

In the depicted embodiment, theorem proving explanation environment 100 includes computing device 102, query 104, proof 106, and network 108. In one or more embodiments, query 104 may be in a natural language from a user. For example, query 104 may be a question like: “does Anne like video games?” Query 104 may be as input theorem proving model 112. Theorem proving model 112 may predict a truth value of query 104 based on knowledge base 124. Proof 106 may be a possible textual explanation for the predicted truth value. Proof 106 may be a set of proofs to explain the predicted truth value of query 104. For example, proof 106 can be in an example explanation like: “Since John likes video games and John is Anne's father and If John is the father of Anne then Anne is a child of John and knowing that every child loves what their father like we can conclude that Anne like videogames.”

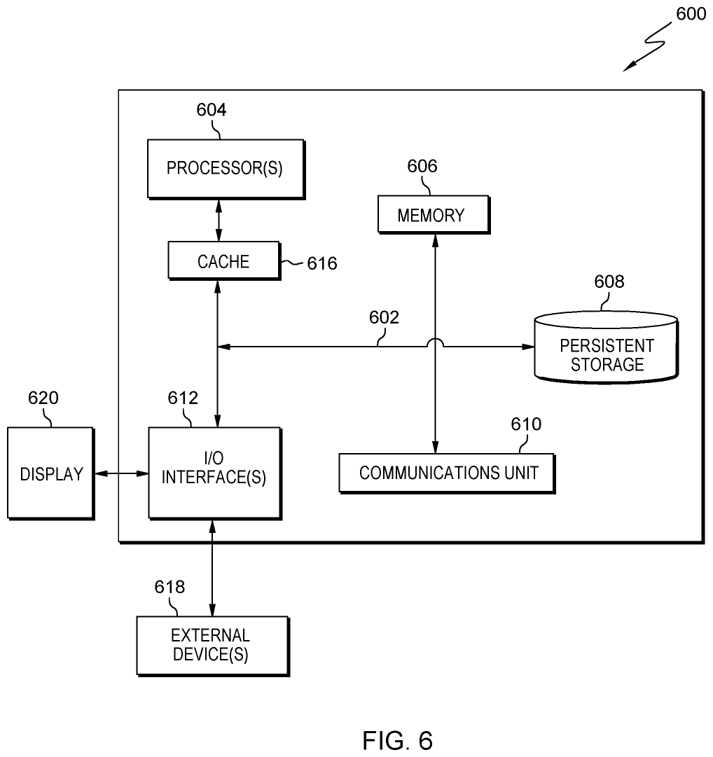

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to cognitive engine 110 and network 108 and is capable of processing program instructions and executing cognitive engine 110, in accordance with an embodiment of the present disclosure. Computing device 102 may include internal and external hardware components, as depicted and described in further detail with respect to FIG. 6.

Further, in the depicted embodiment, computing device 102 includes cognitive engine 110. In the depicted embodiment, cognitive engine 110 is located on computing device 102. However, in other embodiments, cognitive engine 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and cognitive engine 110, in accordance with a desired embodiment of the disclosure.

In the depicted embodiment, cognitive engine 110 includes theorem proving model 112, ranker 114, proof generator 116, and knowledge base 124. In the depicted embodiment, theorem proving model 112, ranker 114, proof generator 116, and knowledge base 124 are located on computing device 102 and cognitive engine 110. However, in other embodiments, theorem proving model 112, ranker 114, proof generator 116, and knowledge base 124 may be located externally and accessed through a communication network such as network 108.

In one or more embodiments, theorem proving model 112 may be a neural theorem prover. Theorem proving model 112 may deal with proving mathematical theorems by computer programs. Theorem proving model 112 may deal with the development of computer programs that show that some statements (e.g., conjecture) are a logical consequence of a set of statements (e.g., axioms). In an example, theorem proving model 112 may be a neural network model for automated theorem proving. Theorem proving model 112 may achieve promising results on queries requiring multiple inference steps. Theorem proving model 112 may support query 104 and knowledge base 124 expressed in a nonformal way (e.g., a natural language). Theorem proving model 112 may provide a prediction of a truth value of a theorem. Theorem proving model 112 may be a pre-trained model. Theorem proving model 112 may be trained in a supervise way for classifying the pairs (knowledge base 124, query 104) as true or false.

In one or more embodiments, knowledge base 124 may include two types of information of facts and rules. Facts may be factual information about entities such as entity properties and relations. Rules may be logical rules. In an example, knowledge base 124 may be a textual knowledge base. For example, facts may be some information like these examples: “Elephant is the biggest animal in the forest”, “Tiger lives in the forest”, “Tiger cannot fit in a small car”, “Horse eats grass”, “Anne has a cat”, “John likes video games”, “John is Anne's father”. Rules may be logical rules like these examples: “All child loves what their father like”, “If Y is a father of X then X is a child of Y”, “If someone has a dog then they may not have a cat”, “If a cat eats dog food then it becomes a fat cat”, “If x does not fit z and y is bigger than x then y does not fit z”.

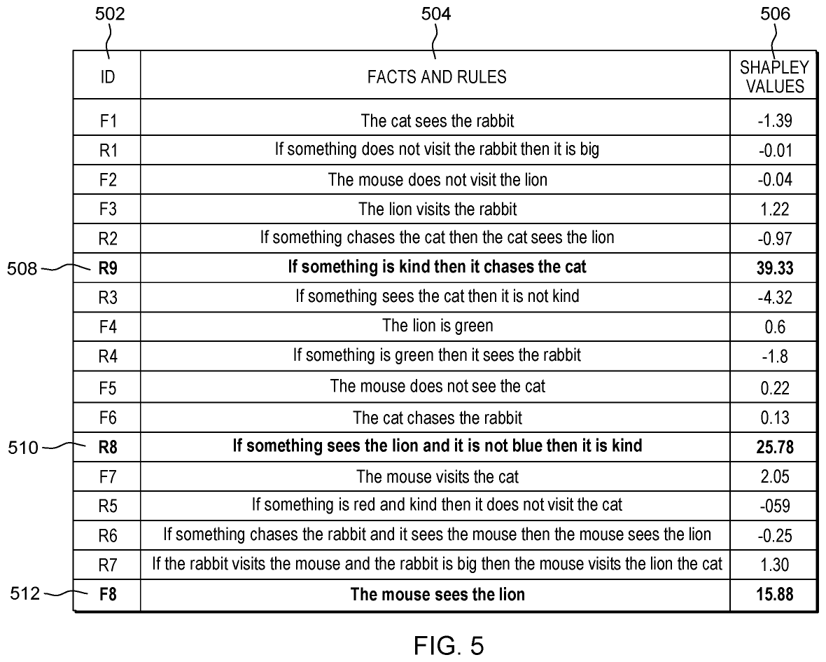

In one or more embodiments, ranker 114 is configured to rank facts and rules according to the contribution made to the predicted truth value of query 104, performed by theorem proving model 112. Ranker 114 may receive, as input, facts and rules in knowledge base 124, a predicted truth value from theorem proving model 112, and query 104. Ranker 114 may output a set of facts and rules ranked by contribution to the predicted truth value. In an example, ranker 114 may use a module-agnostic explanation framework to perform the ranking. In another example, ranker 114 may perform the facts and rules ranking using Shapley values. Further details in perform the facts and rules ranking using Shapley values are depicted and illustrated in an example of FIG. 5.

In one or more embodiments, proof generator 116 is configured to generate an explanation (proof) of the predicted truth value of query 104, wherein the predicted truth value is predicted from theorem proving model 112. Proof generator 116 may generate possible proofs ranked by importance for the predicted truth value of the query. A proof can be a set logical steps that demonstrate the predicted truth value. Proof generator 116 may take, as input, a set of facts and rules ranked by the contribution to the prediction, query 104, the predicted truth value of query 104, and a pre-defined maximum number of proofs. Proof generator 116 may output a ranked list of up to the pre-defined maximum number of proofs for the predicted truth value. Every proof may contain a set of valid paths of reasoning leading to the predicted truth value. In an example, proof generator 116 may apply an inference rule used in logic programming, e.g., selective linear definite clause resolution. Proof generator 116 may replace logical operations with the corresponding lexical counterparts. For example, proof generator 116 may define an and/or search tree of alternative computations. Proof generator 116 may replace the logical operators used in the selective linear definite clause resolution with the following lexical operators: a lexical negation, a query decomposer (which may contain an AND decomposer and an OR decomposer), and a lexical unifier.

In the depicted embodiment, proof generator 116 includes lexical negation 118, query decomposer 120, and lexical unifier 122. In an example, lexical negation 118 is an operator that takes as input a query and provides as output the same query with inverted meaning. For example, after the operation of lexical negation 118, an example query “are Mark and Eric brothers?” becomes “Aren't Mark and Eric brothers?” In one possible embodiment, lexical negation 118 can be implemented with a sequence to sequence neural machine translation model. The input of the sequence to sequence neural machine translation model can be a query and the output is the query with inverted meaning. Training data for the sequence to sequence neural machine translation model can be collected through synthetic generation or crowdsourcing. In another example, query decomposer 120 may be an operator that takes as input a query and provides as output the same query (if no disjunction or conjunction is detected) or the query split into two parts by removing the conjunction or disjunction. In addition, the type of the removed connector is also returned. Query decomposer 120 may include three possible operations: NONE, AND, OR. For example, query decomposer 120 may perform the following example operations: NONE: query decomposer 120 (“The dog runs?”)=([“The dog runs?”], None), AND: query decomposer 120 (“Is there a person who is Mark and Eric's father?”)=([“Is there a person who is Mark's father?”, “Is there a person who is Eric's father?”], And), query decomposer 120 (“Is there a person who is Mark or Eric's teacher?”)=([“Is there a person who is Mark's teacher?”, “Is there a person who is Eric's teacher?”], Or). In one possible embodiment, query decomposer 120 can be implemented with a model (e.g., a neural network-based technique for natural language processing pre-training) able to classify a query in NONE, AND, and OR. Query decomposer 120 may assign a label to every token in the model. For example, query decomposer 120 may assign labels LEFT_SPLIT, RIGHT_SPLIT, BOTH to every token and then splitting accordingly. For example, the tokens of the query in the above example “Is there a person who is Mark and Eric's father” may be classified and subsequently may be split in: [“Is there a person who is Mark father?”, “Is there a person who is Eric's father?”]. Query decomposer 120 may classify the example query as NONE, AND, and OR and subsequently may apply the NONE/AND/OR decomposer accordingly. Query decomposer 120 may collect training data through synthetic generation or crowdsourcing. In another example, lexical unifier 122 is an operator that performs a lexical unification of a given query with a fact or rule, emulating the logical unification. Lexical unifier 122 may take as input query 104 and a given fact or rule in knowledge base 124. Lexical unifier 122 may output a textual unification of query 104 and the given fact/rule. Lexical unifier 122 may output none if lexical unifier 122 cannot perform the unification based on query 104 and the given fact/rule. For example, given a query Q: “are Mark and Eric brothers?” and the rule R1: “if two people are brothers then there is a common father”, lexical unifier 122 may output “is there a person who is both Mark's and Eric's father?” In one possible embodiment, lexical unifier 122 may be implemented with a sequence to sequence neural machine translation model. Lexical unifier 122 may take as input a given query and fact/rule to unify and the output may be either a resolvent, “none” string (if no unification is possible) or the empty string (that correspond to the empty resolvent). Lexical unifier 122 may collect training data through synthetic generation or crowdsourcing.

In one possible embodiment, proof generator 116 may apply lexical negation 118 and may replace query 104 if the predicted truth value for query 104 from theorem proving model is false. Proof generator 116 may apply query decomposer 120 on query 104. Proof generator 116 may apply query decomposer 120 on a left-most sub-query until query decomposer 120 returns NONE (no disjunction or conjunction detected). Proof generator 116 may stack the split outputs in a list and may memorize the corresponding operator. Proof generator 116 may apply lexical unifier 122 between the left-most query and the top-ranked facts or rules (output of ranker 114) for which lexical unifier 122 is not NONE (unification is possible). Proof generator 116 may replace the left-most query with lexical unifier 122 output (the resolvent becomes the new query). At every unification step, proof generator 116 may memorize the sub-query and the resolvent in an AND/OR alternative computation tree, in order to allow back-tracking in case of failure. If proof generator 116 cannot apply lexical unifier 122 to any fact or rule back-track to the last choose-point and if no choose-point is present, proof generator 116 may terminate applying lexical unifier 122. Proof generator 116 may apply query decomposer 120 on a left-most sub-query until query decomposer 120 returns an empty sentence. If there is any AND branch in the search tree, proof generator 116 may apply query decomposer 120 on a left-most sub-query until query decomposer 120 returns an empty sentence. Proof generator 116 may end successfully and may add the branch to the proof set. When the procedure ends successfully, proof generator 116 may aggregate the resolvents for every branch in the proof set to create textual proofs. Proof generator 116 may indicate that there are no facts/rules sufficient to answer query 104, which is therefore considered false. Proof generator 116 may obtain a proof rank value by multiplying all the predictions confidence of each probabilistic model used in deriving the branch. Proof generator 116 may improve a model prediction by integrating user-provided feedback. Proof generator 116 may train lexical operators in a supervised way. Proof generator 116 may directly update the model predictions (with retraining or online learning) based on the feedback.

In one or more embodiments, cognitive engine 110 is configured to compute a proof of a predicted truth value of theorem proving model 112 based on natural language. Theorem proving model 112 may be pre-trained. Cognitive engine 110 may take, as input, facts and rules in knowledge base 124, and query 104. The facts and rules may be expressed in a natural language. Query 104 may be expressed in a natural language. Cognitive engine 110 may take as input the predicted truth value of theorem proving model 112. Cognitive engine 110 may take as input a pre-defined value indicating the maximum number of expected proofs. Cognitive engine 110 may output a sorted set of top proofs of the predicted truth value for query 104 computed by theorem proving model 112. Cognitive engine 110 may rank a proof based on a score that represents the estimated accuracy of the proof. The proof may include a proof path. A proof path may be the sequences of facts and/or rules from knowledge base 124 that proves the predicted truth value of query 104. Each proof may have a single path. Each proof is a possible explanation of how theorem proving model 112 uses the information in knowledge base 124 to prove query 104. In an example, a user (e.g., a domain expert) may provide feedback on the proof produced as output by cognitive engine 110. The feedback may include quantitative indication of the correctness/usefulness of the proof. Cognitive engine 110 may use previously collected user feedback to improve the accuracy of the computation.

In one or more embodiments, cognitive engine 110 is configured to rank facts and rules according to the contribution made to the predicted truth value of query 104, performed by theorem proving model 112. Cognitive engine 110 may receive, as input, facts and rules in knowledge base 124, a predicted truth value from theorem proving model 112, and query 104. Cognitive engine 110 may output a set of facts and rules ranked by contribution to the predicted truth value. In an example, cognitive engine 110 may use a module-agnostic explanation framework to perform the ranking. In another example, cognitive engine 110 may perform the facts and rules ranking using Shapley values.

In one or more embodiments, cognitive engine 110 is configured to generate an explanation (proof) of the predicted truth value of query 104, wherein the predicted truth value is predicted from theorem proving model 112. Cognitive engine 110 may generate possible proofs ranked by importance for the predicted truth value of the query. A proof can be a set logical steps that demonstrate the predicted truth value. Cognitive engine 110 may take, as input, a set of facts and rules ranked by the contribution to the prediction, query 104, the predicted truth value of query 104, and a pre-defined maximum number of proofs. Cognitive engine 110 may output a ranked list of up to the pre-defined maximum number of proofs for the predicted truth value. Every proof may contain a set of valid paths of reasoning leading to the predicted truth value. In an example, cognitive engine 110 may apply an inference rule used in logic programming, e.g., selective linear definite clause resolution Cognitive engine 110 may replace logical operations with the corresponding lexical counterparts. For example, cognitive engine 110 may define a search tree of alternative computations. Cognitive engine 110 may replace the logical operators used in the selective linear definite clause resolution with the following lexical operators: a lexical negation, a query decomposer (which may contain an AND decomposer and an OR decomposer), and a lexical unifier.

Cognitive engine 110 may take as input a query and may provide as output the same query with inverted meaning. For example, after the operation of lexical negation 118, an example query “are Mark and Eric brothers?” becomes “Aren't Mark and Eric brothers?” In one possible embodiment, lexical negation 118 can be implemented with a sequence to sequence neural machine translation model. The input of the sequence to sequence neural machine translation model can be a query and the output is the query with an inverted meaning. Training data for the sequence to sequence neural machine translation model can be collected through synthetic generation or crowdsourcing. In another example, cognitive engine 110 may take as input a query and may provide as output the same query (if no disjunction or conjunction is detected) or the query split into two parts by removing the conjunction or disjunction. In addition, the type of the removed connector may also be returned. Query decomposer 120 may include three possible operations: NONE, AND, OR. For example, query decomposer 120 may perform the following example operations: NONE: query decomposer 120 (“The dog runs?”)=([“The dog runs?”], None), AND: query decomposer 120 (“Is there a person who is Mark and Eric's father?”)=([“Is there a person who is Mark's father?”, “Is there a person who is Eric's father?”], And), query decomposer 120 (“Is there a person who is Mark or Eric's teacher?”)=([“Is there a person who is Mark's teacher?”, “Is there a person who is Eric's teacher?”], Or). In one possible embodiment, query decomposer 120 can be implemented with a model (e.g., a neural network-based technique for natural language processing pre-training) able to classify a query in NONE, AND, and OR. Query decomposer 120 may assign a label to every token in the model. For example, query decomposer 120 may assign labels LEFT_SPLIT, RIGHT_SPLIT, BOTH to every token and then splitting accordingly. For example, the tokens of the query in the above example “Is there a person who is Mark and Eric's father” may be classified and subsequently may be split in: [“Is there a person who is Mark father?”, “Is there a person who is Eric's father?”]. Query decomposer 120 may classify the example query as NONE, AND, and OR and subsequently may apply the NONE/AND/OR decomposer accordingly. Query decomposer 120 may collect training data through synthetic generation or crowdsourcing. In another example, cognitive engine 110 may perform a lexical unification of a given query with a fact or rule, emulating the logical unification. Cognitive engine 110 may take as input query 104 and a given fact or rule in knowledge base 124. Cognitive engine 110 may output a textual unification of query 104 and the given fact/rule. Cognitive engine 110 may output none if cognitive engine 110 cannot perform the unification based on query 104 and the given fact/rule. For example, given a query Q: “are Mark and Eric brothers?” and the rule R1: “if two people are brothers then there is a common father”, cognitive engine 110 may output “is there a person who is both Mark's and Eric's father?” In one possible embodiment, lexical unifier 122 may be implemented with a sequence to sequence neural machine translation model. Lexical unifier 122 may take as input a given query and fact/rule to unify and the output may be either a resolvent, “none” string (if no unification is possible) or the empty string (that correspond to the empty resolvent). Lexical unifier 122 may collect training data through synthetic generation or crowdsourcing.

In one possible embodiment, cognitive engine 110 may apply lexical negation 118 and may replace query 104 if the predicted truth value for query 104 from theorem proving model is false. Cognitive engine 110 may apply query decomposer 120 on query 104. Cognitive engine 110 may apply query decomposer 120 on a left-most sub-query until query decomposer 120 returns NONE (no disjunction or conjunction detected). Cognitive engine 110 may stack the split outputs in a list and may memorize the corresponding operator. Cognitive engine 110 may apply lexical unifier 122 between the left-most query and the top-ranked facts or rules (output of ranker 114) for which lexical unifier 122 is not NONE (unification is possible). Cognitive engine 110 may replace the left-most query with lexical unifier 122 output (the resolvent become the new query). At every unification step, proof generator 116 may memorize the sub-query and the resolvent in an AND/OR alternative computation tree, in order to allow back-tracking in case of failure. If cognitive engine 110 cannot apply lexical unifier 122 to any fact or rule back-track to the last choose-point and if no choose-point is present, cognitive engine 110 may terminate applying lexical unifier 122. Cognitive engine 110 may apply query decomposer 120 on a left-most sub-query until query decomposer 120 returns an empty sentence. If there is any AND branch in the search tree, cognitive engine 110 may apply query decomposer 120 on a left-most sub-query until query decomposer 120 returns an empty sentence. Cognitive engine 110 may end successfully and may add the branch to the proof set. When the procedure ends successfully, cognitive engine 110 may aggregate the resolvents for every branch in the proof set to create textual proofs. Cognitive engine 110 may indicate that there are no facts/rules sufficient to answer query 104, which is therefore considered false. Cognitive engine 110 may obtain a proof rank value by multiplying all the predictions confidence of each probabilistic model used in deriving the branch. Cognitive engine 110 may improve a model prediction by integrating user-provided feedback. Cognitive engine 110 may train lexical operators in a supervised way. Cognitive engine 110 may directly update the model predictions (with retraining or online learning) based on the feedback.

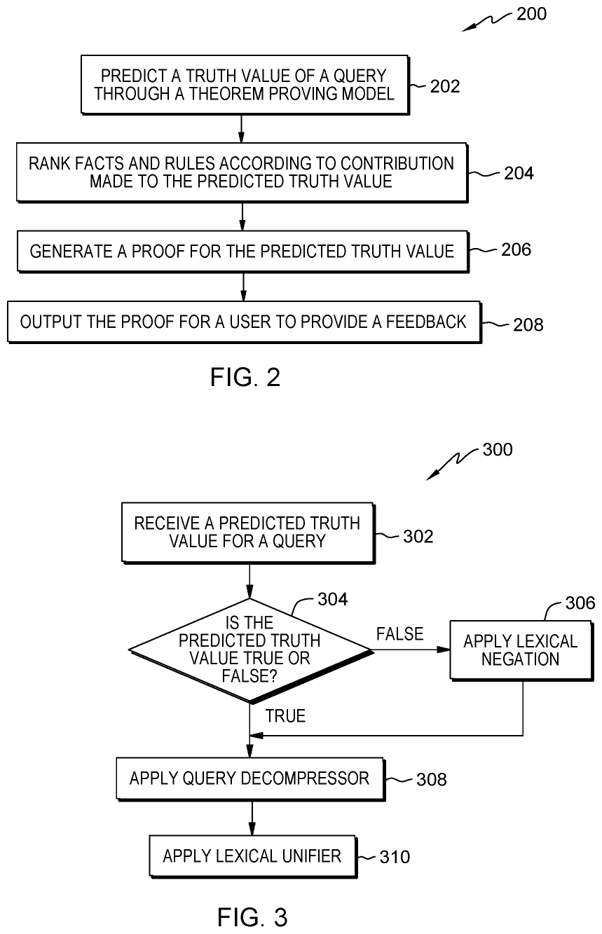

FIG. 2 is a flowchart 200 depicting operational steps of cognitive engine 110 in accordance with an embodiment of the present disclosure.

Cognitive engine 110 operates to predict a truth value of query 104 through theorem proving model 112, based on query 104 and facts and rules in knowledge base 124. Cognitive engine 110 also operates to rank facts and rules in knowledge base 124 according to the contribution made to the predicted truth value of query 104. Cognitive engine 110 operates to generate proof 106 of the predicted truth value of query 104, wherein the predicted truth value is predicted from theorem proving model 112 for query 104. Cognitive engine 110 operates to output proof 106 for a user to provide a feedback.

In step 202, cognitive engine 110 predicts a truth value of query 104 through theorem proving model 112, based on query 104 and facts and rules in knowledge base 124. The facts and rules may be expressed in a natural language. Query 104 may be expressed in a natural language. Theorem proving model 112 may be a neural theorem prover. Theorem proving model 112 may deal with proving mathematical theorems by computer programs. Theorem proving model 112 may deal with the development of computer programs that show that some statements (e.g., conjecture) are a logical consequence of a set of statements (e.g., axioms). In an example, theorem proving model 112 may be a neural network model for automated theorem proving. Theorem proving model 112 may achieve promising results on queries requiring multiple inference steps. Theorem proving model 112 may support query 104 and knowledge base 124 expressed in a nonformal way (e.g., a natural language). Theorem proving model 112 may provide a prediction of a truth value of a theorem. Theorem proving model 112 may be a pre-trained model. Theorem proving model 112 may be trained in a supervise way for classifying the pairs (knowledge base 124, query 104) as true or false.

In step 204, cognitive engine 110 ranks facts and rules in knowledge base 124 according to the contribution, calculated in a pre-defined scoring way, made to the predicted truth value of query 104, performed by theorem proving model 112. Cognitive engine 110 may receive, as input, the facts and rules in knowledge base 124, the predicted truth value from theorem proving model 112, and query 104. Cognitive engine 110 may output a set of facts and rules ranked by contribution to the predicted truth value. In an example, cognitive engine 110 may use a module-agnostic explanation framework to perform the ranking. For example, a module-agnostic explanation framework can be an explanation technique that explains the predictions of any classifier in an interpretable and faithful manner, by learning an interpretable model locally around the prediction. A module-agnostic explanation framework may explain a model by presenting representative individual predictions and the explanations in a non-redundant way, framing the task as a submodular optimization problem. In another example, cognitive engine 110 may perform the facts and rules ranking using Shapley values. The Shapley values may be then computed and used as feature attributions. Cognitive engine 110 may compute which features contribute to the prediction. Shapley values may be as a unified measure of feature importance. Shapley values may be of a conditional expectation function of an original model.

In step 206, cognitive engine 110 generates proof 106 of the predicted truth value of query 104, wherein the predicted truth value is predicted from theorem proving model 112 for query 104. Proof may be one or more logical steps that demonstrate the predicted truth value in a natural language. Cognitive engine 110 may compute proof 106 of the predicted truth value of theorem proving model 112 based on a natural language. Cognitive engine 110 may generate possible proofs ranked by importance for the predicted truth value of query 104. Proof 106 can be a set logical steps that demonstrate the predicted truth value. Cognitive engine 110 may take, as input, a set of facts and rules ranked by the contribution to the prediction, query 104, the predicted truth value of query 104, and a pre-defined maximum number of proofs. Cognitive engine 110 may output a ranked list of up to the pre-defined maximum number of proofs for the predicted truth value. Every proof may contain a valid path of reasoning leading to the predicted truth value. In an example, cognitive engine 110 may apply an inference rule used in logic programming, e.g., selective linear definite clause resolution Cognitive engine 110 may replace logical operations with the corresponding lexical counterparts. For example, cognitive engine 110 may define a search tree of alternative computations. Cognitive engine 110 may replace the logical operators used in the selective linear definite clause resolution with the following lexical operators: a lexical negation, a query decomposer (which may contain an AND decomposer and an OR decomposer), and a lexical unifier.

Cognitive engine 110 may take as input a query and may provide as output the same query with inverted meaning. For example, after the operation of lexical negation 118, an example query “are Mark and Eric brothers?” becomes “Aren't Mark and Eric brothers?” In one possible embodiment, lexical negation 118 can be implemented with a sequence to sequence neural machine translation model. The input of the sequence to sequence neural machine translation model can be a query and the output is the query with an inverted meaning. Training data for the sequence to sequence neural machine translation model can be collected through synthetic generation or crowdsourcing. An alternative solution is to negate a sentence is to use an abstract meaning representation parser to turn the input text into an abstract meaning representation graph, then add/remove a polarity relation to the root node of the abstract meaning representation, then use an abstract meaning representation to text model to turn the inverted AMR back to a new sentence with negated meaning. In another example, cognitive engine 110 may take as input a query and may provide as output the same query (if no disjunction or conjunction is detected) or the query split into two parts by removing the conjunction or disjunction. In addition, the type of the removed connector may also be returned. Query decomposer 120 may include three possible operations: NONE, AND, OR. For example, query decomposer 120 may perform the following example operations: NONE: query decomposer 120 (“The dog runs?”)=([“The dog runs?”], None), AND: query decomposer 120 (“Is there a person who is Mark and Eric's father?”)=([“Is there a person who is Mark's father?”, “Is there a person who is Eric's father?”], And), query decomposer 120 (“Is there a person who is Mark or Eric's teacher?”)=([“Is there a person who is Mark's teacher?”, “Is there a person who is Eric's teacher?”], Or). In one possible embodiment, query decomposer 120 can be implemented with a model (e.g., a neural network-based technique for natural language processing pre-training) able to classify a query in NONE, AND, and OR. Query decomposer 120 may assign a label to every token in the model. For example, query decomposer 120 may assign labels LEFT_SPLIT, RIGHT_SPLIT, BOTH to every token and then splitting accordingly. For example, the tokens of the query in the above example “Is there a person who is Mark and Eric's father” may be classified and subsequently may be split in: [“Is there a person who is Mark father?”, “Is there a person who is Eric's father?”]. Query decomposer 120 may classify the example query as NONE, AND, and OR and subsequently may apply the NONE/AND/OR decomposer accordingly. Query decomposer 120 may collect training data through synthetic generation or crowdsourcing. In another example, cognitive engine 110 may perform a lexical unification of a given query with a fact or rule, emulating the logical unification. Cognitive engine 110 may take as input query 104 and a given fact or rule in knowledge base 124. Cognitive engine 110 may output a textual unification of query 104 and the given fact/rule. Cognitive engine 110 may output none if cognitive engine 110 cannot perform the unification based on query 104 and the given fact/rule. For example, given a query Q: “are Mark and Eric brothers?” and the rule R1: “if two people are brothers then there is a common father”, cognitive engine 110 may output “is there a person who is both Mark's and Eric's father?” In one possible embodiment, lexical unifier 122 may be implemented with a sequence to sequence neural machine translation model. An alternative solution is to use an abstract meaning representation parser to turn the input text into an abstract meaning representation graph. An abstract meaning representation graph may have AND, OR nodes which can be used to identify the place to decompose the sentences. Lexical unifier 122 may take as input a given query and fact/rule to unify and the output may be either a resolvent, “none” string (if no unification is possible) or the empty string (that correspond to the empty resolvent). Lexical unifier 122 may collect training data through synthetic generation or crowdsourcing.

In one possible embodiment, cognitive engine 110 may apply lexical negation 118 and may replace query 104 if the predicted truth value for query 104 from theorem proving model is false. Cognitive engine 110 may apply query decomposer 120 on query 104. Cognitive engine 110 may apply query decomposer 120 on a left-most sub-query until query decomposer 120 returns NONE (no disjunction or conjunction detected). Cognitive engine 110 may stack the split outputs in a list and may memorize the corresponding operator. Cognitive engine 110 may apply lexical unifier 122 between the left-most query and the top-ranked facts or rules (output of ranker 114) for which lexical unifier 122 is not NONE (unification is possible). Cognitive engine 110 may replace the left-most query with lexical unifier 122 output (the resolvent becomes a new query). At every unification step, proof generator 116 may memorize the sub-query and the resolvent in an AND/OR alternative computation tree, in order to allow back-tracking in case of failure. If cognitive engine 110 cannot apply lexical unifier 122 to any fact or rule back-track to the last choose-point and if no choose-point is present, cognitive engine 110 may terminate applying lexical unifier 122. Cognitive engine 110 may apply query decomposer 120 on a left-most sub-query until query decomposer 120 returns an empty sentence. If there is any AND branch in the search tree, cognitive engine 110 may apply query decomposer 120 on a left-most sub-query until query decomposer 120 returns an empty sentence. Cognitive engine 110 may end successfully and may add the branch to the proof set. When the procedure ends successfully, cognitive engine 110 may aggregate the resolvents for every branch in the proof set to create textual proofs. Cognitive engine 110 may indicate that there are no facts/rules sufficient to answer query 104, which is therefore considered false. Cognitive engine 110 may obtain a proof rank value by multiplying all the predictions confidence of each probabilistic model used in deriving the branch. Cognitive engine 110 may improve a model prediction by integrating user-provided feedback. Cognitive engine 110 may train lexical operators in a supervised way. Cognitive engine 110 may directly update the model predictions (with retraining or online learning) based on the feedback.

In step 208, cognitive engine 110 outputs proof 106 for a user to provide a feedback. Cognitive engine 110 may output a sorted set of top proofs of the predicted truth value for query 104 computed by theorem proving model 112. Cognitive engine 110 may rank proof 106 based on a score that represents the estimated accuracy of proof 106. Proof 106 may include a logical proof path. A logical proof path may be the sequences of facts and/or rules from knowledge base 124 that proves the predicted truth value of query 104. Each proof may have a single path. Each proof is a possible explanation of how theorem proving model 112 uses the information in knowledge base 124 to prove query 104. In an example, a user (e.g., a domain expert) may provide feedback on proof 106 produced as output by cognitive engine 110. The feedback may include quantitative indication of the correctness/usefulness of proof 106. Cognitive engine 110 may use previously collected user feedback to improve the accuracy of the computation.

FIG. 3 is a flowchart 300 depicting operational steps of proof generator 116 of cognitive engine 110 in accordance with an embodiment of the present disclosure.

Proof generator 116 operates to receive a predicted truth value of query 104 from theorem proving model 112. Proof generator 116 also operates to determine whether the predicted truth value of query 104 is true or false. If proof generator 116 determines that the predicted truth value of query 104 is false, proof generator 116 operates to apply lexical negation 118. If proof generator 116 determines that the predicted truth value of query 104 is true, proof generator 116 operates to apply query decomposer 120. Proof generator 116 operates to apply lexical unifier 122. Proof generator 116 operates to perform a lexical unification of query 104 with a given fact or rule in knowledge base 124.

In step 302, proof generator 116 receives a predicted truth value of query 104 from theorem proving model 112. Proof generator 116 may also receive, as input, query 104, a set of facts and rules ranked by the contribution to the prediction, and a pre-defined maximum number of proofs. In decision 304, proof generator 116 determines whether the predicted truth value of query 104 is true or false. If proof generator 116 determines that the predicted truth value of query 104 is false (decision 304, “FALSE” branch), in step 306, proof generator 116 applies lexical negation 118. Proof generator 116 may take as input query 104 and may provide as output the same query with inverted meaning. Proof generator 116 may replace query 104 if the predicted truth value for query 104 from theorem proving model 112 is false. In an example, lexical negation 118 can be a sequence to sequence neural machine translation model.

If proof generator 116 determines that the predicted truth value of query 104 is true (decision 304, “TRUE” branch), in step 308, proof generator 116 applies query decomposer 120. Proof generator 116 may take as input query 104 or the inverted meaning of query 104 from step 306. Query decomposer 120 may include three possible operations: NONE, AND, OR. In an example, query decomposer 120 may be a model (e.g., a neural network-based technique for natural language processing pre-training) able to classify a query in NONE, AND, and OR. Query decomposer 120 may determine whether there is conjunction or disjunction detected in query 104. Conjunction may be an operation on two logical values that produces a value of true if and only if both of operands are true. Conjunction may be a logical connective whose meaning either refines or corresponds to that of natural language expressions such as “and”. Disjunction may be a logical connective whose meaning either refines or corresponds to that of natural language expressions such as “or”. If query decomposer 120 determines that there is no conjunction or disjunction detected in query 104, query decomposer may perform NONE operation and may simply output the same query of query 104. If query decomposer 120 determines that there is a conjunction detected in query 104, query decomposer may perform AND operation. Query decomposer 120 may split query 104 into two parts by removing the conjunction. Query decomposer 120 may return the type of the removed connector. If query decomposer 120 determines that there is a disjunction detected in query 104, query decomposer may perform OR operation. Query decomposer 120 may split query 104 into two parts by removing the disjunction. Query decomposer 120 may return the type of the removed connector. Proof generator 116 may apply query decomposer 120 on a left-most sub-query until query decomposer 120 returns NONE (no disjunction or conjunction detected). Proof generator 116 may stack the split outputs in a list and may memorize the corresponding operator.

In step 310, proof generator 116 applies lexical unifier 122. Proof generator 116 may perform a lexical unification of query 104 with a given fact or rule in knowledge base 124. The given fact or rule may be a ranked fact or rule from ranker 114. Proof generator 116 may output a textual unification of query 104 and the given fact or rule. Proof generator 116 may apply lexical unifier 122 between the left-most query and the top-ranked facts or rules (output of ranker 114) for which lexical unifier 122 is not NONE (unification is possible). Proof generator 116 may replace the left-most query with lexical unifier 122 output (the resolvent becomes a new query). At every unification step, proof generator 116 may memorize the sub-query and the resolvent in an AND/OR alternative computation tree, in order to allow back-tracking in case of failure. If proof generator 116 cannot apply lexical unifier 122 to any fact or rule back-track to the last choose-point and if no choose-point is present, cognitive engine 110 may terminate applying lexical unifier 122. Proof generator 116 may apply query decomposer 120 on a left-most sub-query until query decomposer 120 returns an empty sentence. If there is any AND branch in the search tree, proof generator 116 may apply query decomposer 120 on a left-most sub-query until query decomposer 120 returns an empty sentence. Proof generator 116 may end successfully and may add the branch to the proof set. When the procedure ends successfully, proof generator 116 may aggregate the resolvents for every branch in the proof set to create textual proofs. Proof generator 116 may indicate that there are no facts/rules sufficient to answer query 104, which is therefore considered false.

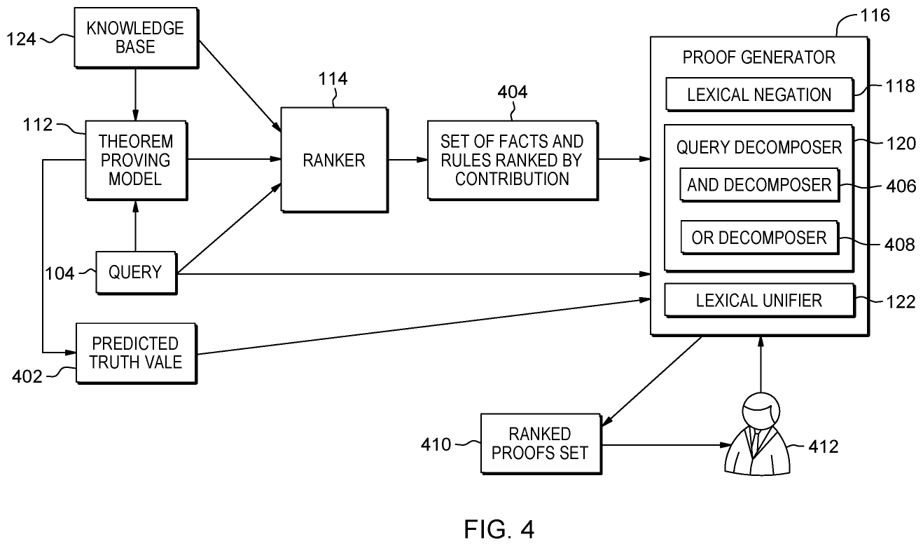

FIG. 4 illustrates an exemplary functional diagram of cognitive engine 110, in accordance with an embodiment of the present disclosure.

In the example of FIG. 4, theorem proving model 112 may predict a truth value of query 104, based on query 104 and facts and rules in knowledge base 124. Theorem proving model 112 may be a pre-trained model. Theorem proving model 112 may be a neural theorem prover. Theorem proving model 112 may be a neural network model for automated theorem proving. Theorem proving model 112 may output predicted truth value 402 to ranker 114 and proof generator 116. Ranker 114 may rank facts and rules in knowledge base 124 according to the contribution made to predicted truth value 402 of query 104, performed by theorem proving model 112. Ranker 114 may receive, as input, the facts and rules in knowledge base 124, predicted truth value 402, and query 104. Ranker 114 may output a set of facts and rules 404 ranked by contribution to predicted truth value 402. In an example, ranker 114 may be a module-agnostic explanation framework to perform the ranking. In another example, ranker 114 may perform the facts and rules ranking using Shapley values. Proof generator 116 may generate ranked proofs set 410 (e.g., proof 106) of predicted truth value 402 of query 104. Proof generator 116 may take, as input, a set of facts and rules 404 ranked by the contribution to the prediction, query 104, predicted truth value 402, and a pre-defined maximum number of proofs. Proof generator 116 may output ranked proofs set 410 up to the pre-defined maximum number of proofs for predicted truth value 402. Every proof in ranked proofs set 410 may contain a set of valid paths of reasoning leading to predicted truth value 402. Proof generator 116 includes lexical negation 118, query decomposer 120, and lexical unifier 122. Query decomposer 120 may include AND decomposer 406 and OR decomposer 408. Proof generator 116 may output ranked proofs set 410 for user 412 to provide a feedback. Proof generator 116 may rank proof 106 based on a score that represents the estimated accuracy of proof 106. User 412 (e.g., a domain expert) may provide feedback on ranked proofs set 410. The feedback may include quantitative indication of the correctness/usefulness of ranked proofs set 410.

FIG. 5 is an example table illustrating ranking facts and rules using Shapley values of ranker 114 in cognitive engine 110, in accordance with an embodiment of the present disclosure.

In the example of FIG. 5, column 502 lists identification (ID) for each fact and rule from knowledge base 124. Column 504 lists facts and rules. Column 506 lists Shapley values for each fact and rule respectively. Ranker 114 may rank the facts and rules using Shapley values. For example, for an example query “does the mouse chase the cat?”, theorem proving model 112 predicts a truth value of the example query is true. Ranker 114 may rank three most important facts and rules 508, 510, 512 correctly based on Shapley values shown on column 506.

FIG. 6 depicts a block diagram 600 of components of computing device 102 in accordance with an illustrative embodiment of the present disclosure. It should be appreciated that FIG. 6 provides only an illustration of one implementation and does not imply any limitations with regard to the environments in which different embodiments may be implemented. Many modifications to the depicted environment may be made.

Computing device 102 may include communications fabric 602, which provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Cognitive engine 110 may be stored in persistent storage 608 and in memory 606 for execution by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Cognitive engine 110 may be downloaded to persistent storage 608 through communications unit 610.

I/O interface(s) 612 allows for input and output of data with other devices that may be connected to computing device 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., cognitive engine 110 can be stored on such portable computer readable storage media and can be loaded onto persistent storage 408 via I/O interface(s) 612. I/O interface(s) 612 also connect to display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
predicting, by one or more processors, a truth value of a query through a pre-trained theorem proving model, based on the query and one or more facts and rules in a knowledge base;
ranking, by one or more processors, the one or more facts and rules according to contribution, calculated in a pre-defined scoring method, made to the predicted truth value of the query;
generating, by one or more processors, a proof of the predicted truth value, wherein the proof is one or more logical steps that demonstrate the predicted truth value in a natural language; and
outputting, by one or more processors, the proof.

2. The computer-implemented method of claim 1, wherein generating the proof of the predicted truth value comprises taking, as input, the one or more ranked facts and rules, the query, the predicted truth value, and a pre-defined maximum number of proofs.

3. The computer-implemented method of claim 2, wherein outputting the proof comprises outputting a sorted set of the pre-defined maximum number of proofs of the predicted truth value for the query, wherein each proof is ranked based on a score that represents estimated accuracy of the proof.

4. The computer-implemented method of claim 1, wherein the proof includes one or more logical proofing paths, wherein the one or more proving paths prove the predicted truth value with a possible explanation of how the pre-trained theorem proving model uses the one or more facts and rules in the knowledge base to prove the query.

5. The computer-implemented method of claim 1, wherein generating the proof comprises:
decomposing the query; and
unifying the query with the one or more facts and rules.

6. The computer-implemented method of claim 5, wherein generating the proof comprises negating the query when the predicted truth value is false.

7. The computer-implemented method of claim 1, further comprising:
receiving, by one or more processors, feedback from a user based on the proof, the feedback including quantitative indication of the proof; and
using, by one or more processors, previously collected user feedback to improve the accuracy of generating the proof.

8. A computer program product comprising:
one or more computer readable storage media, and program instructions collectively stored on the one or more computer readable storage media, the program instructions comprising:
program instructions to predict a truth value of a query through a pre-trained theorem proving model, based on the query and one or more facts and rules in a knowledge base;
program instructions to rank the one or more facts and rules according to contribution, calculated in a pre-defined scoring method, made to the predicted truth value of the query;
program instructions to generate a proof of the predicted truth value, wherein the proof is one or more logical steps that demonstrate the predicted truth value in a natural language; and
program instructions to output the proof.

9. The computer program product of claim 8, wherein program instructions to generate the proof of the predicted truth value comprise program instructions to take, as input, the one or more ranked facts and rules, the query, the predicted truth value, and a pre-defined maximum number of proofs.

10. The computer program product of claim 9, wherein program instructions to output the proof comprise program instructions to output a sorted set of the pre-defined maximum number of proofs of the predicted truth value for the query, wherein each proof is ranked based on a score that represents estimated accuracy of the proof.

11. The computer program product of claim 8, wherein the proof includes one or more logical proofing paths, wherein the one or more proving paths prove the predicted truth value with a possible explanation of how the pre-trained theorem proving model uses the one or more facts and rules in the knowledge base to prove the query.

12. The computer program product of claim 8, wherein program instructions to generate the proof comprise:
program instructions to decompose the query; and
program instructions to unify the query with the one or more facts and rules.

13. The computer program product of claim 8, wherein program instructions to generate the proof comprise program instructions to negate the query when the predicted truth value is false.

14. The computer program product of claim 8, further comprising:
program instructions to receive feedback from a user based on the proof, the feedback including quantitative indication of the proof; and
program instructions to use previously collected user feedback to improve the accuracy of generating the proof.

15. A computer system comprising:
one or more computer processors, one or more computer readable storage media, and program instructions stored on the one or more computer readable storage media for execution by at least one of the one or more computer processors, the program instructions comprising:
program instructions to predict a truth value of a query through a pre-trained theorem proving model, based on the query and one or more facts and rules in a knowledge base;
program instructions to rank the one or more facts and rules according to contribution, calculated in a pre-defined scoring method, made to the predicted truth value of the query;
program instructions to generate a proof of the predicted truth value, wherein the proof is one or more logical steps that demonstrate the predicted truth value in a natural language; and
program instructions to output the proof.

16. The computer system of claim 15, wherein program instructions to generate the proof of the predicted truth value comprise program instructions to take, as input, the one or more ranked facts and rules, the query, the predicted truth value, and a pre-defined maximum number of proofs.

17. The computer system of claim 16, wherein program instructions to output the proof comprise program instructions to output a sorted set of the pre-defined maximum number of proofs of the predicted truth value for the query, wherein each proof is ranked based on a score that represents estimated accuracy of the proof.

18. The computer system of claim 15, wherein the proof includes one or more logical proofing paths, wherein the one or more proving paths prove the predicted truth value with a possible explanation of how the pre-trained theorem proving model uses the one or more facts and rules in the knowledge base to prove the query.

19. The computer system of claim 15, wherein program instructions to generate the proof comprise:
program instructions to decompose the query; and
program instructions to unify the query with the one or more facts and rules.

20. The computer system of claim 15, wherein program instructions to generate the proof comprise program instructions to negate the query when the predicted truth value is false.
